(19) United States
(12) Patent Application Publication
(10) Pub. No.: US 2006/0037150 A1
(43) Pub. Date: Feb. 23, 2006

(54) Compositions and methods for treating textiles to impart wrinkle resistance, softness and hydrophilicity

(76) Inventors: David A. Offord, Castro Valley, CA (US); Cheng Hu, Oakland, CA (US)

Correspondence Address: MORRISON & FOERSTER LLP, 755 PAGE MILL RD, PALO ALTO, CA, 94304-1018, US

(21) Appl. No.: 11/209,251

(22) Filed: Aug. 22, 2005

Related U.S. Application Data
(60) Provisional application No. 60/603,720, filed on Aug. 23, 2004.
(60) Provisional application No. 60/618,270, filed on Oct. 12, 2004.

(51) Int. Cl. C11D 3/00

(52) U.S. Cl. 8/115.51

(57) ABSTRACT

The present application relates to the treatment of textiles to impart wrinkle resistance and softness while maintaining the natural hydrophilicity of the substrate. In one embodiment, it relates to the treatment of linear polymers, yarns, fibers, webs, mesches, fabrics and other fibrous substrates to provide a textile finish that resists wrinkles and remains soft to the touch.

### CROSS-REFERENCE TO RELATED APPLICATIONS

This application claims the benefit under 35 U.S.C. §119(e) of U.S. Provisional Application No. 60/603,720, filed Aug. 23, 2004, and U.S. Provisional Application No. 60/618,270, filed Oct. 12, 2004, the disclosures of which are hereby incorporated by reference in their entirety.

### BACKGROUND OF THE INVENTION

Textiles are used in the manufacture of a wide variety of goods, such as apparel, furniture, household items, automobile accessories, medical supplies, and the like. As used herein, the term “textiles” generally refers to cloth or fabric that is composed of fiber, filament or yarn. In the form of cloth or fabric, it is desirable for textiles to be hydrophilic and resist wrinkles, while not being stiff to the touch. It is also desirable for the hydrophilicity of the textile to be durable and for the strength of the textile, compared to untreated textile, to be maintained or enhanced.

Textiles can be made of a number of natural and synthetic materials. Perhaps the most common natural material is cotton, which consists of linearly arranged cellulose fibers (i.e. “cotton fibers”) that are organized into a complex nanostructure. Cotton fabric is formed from interwoven cotton fibers, which are in turn formed from linear cellulose molecules, or “chains.” The cellulose molecules are held together by hydrogen bonds, which stabilize the nanostructure. However, these bonds are easily broken and reformed, which results in “slippage” of one or more cellulose molecules relative to one another.

Once slippage occurs, hydrogen bonds reform between the newly positioned cellulose molecules within the cotton fibers. If the repositioned fibers have formed a wrinkle, reformation of hydrogen bonds locks the wrinkle in place. Thereafter, the only way to remove the wrinkle is to break the hydrogen bonds once again, most usually through the application of moisture and/or heat. The most common example of this process is when clothes dry in a wrinkled state, and a steam iron is used to apply heat to remove the wrinkles. Garments with this type of finish are identified by names such as “Easy Care,” Durable Press,” “Minimum Care,” “Easy to Iron,” “Permanent Press,” “Crease Resistant,” “Shrink Proof,” “Wrinkle Free,” “Wrinkle-Resistant,” “Wash and Wear,” and “No-Iron.”

Since 1965 consumers have been able to buy all-cotton shirts that are durable and yet look newly pressed after repeated launderings and dryings. The key to making cotton wash-and-wear—or durable press, as it is now called—is to treat the cotton with a chemical solution which reacts with the cellulose molecules that compose cotton fiber. The treatment “crosslinks” or ties the molecules together so that the fabric will dry smooth after laundering. See, for example, W. D. Schindler and P. J. Hauser; Chemical Finishing of Textiles; Woodhead Publishing Limited, Cambridge England, 2004, Chapter 5: “Easy-Care and Durable Press Finishes of Cellulosics”; pp 51-72, and references cited therein.

Cellulose is made up of repeating anhydroglucose units. Each unit contains two secondary and one primary alcohol groups. To achieve wrinkle resistance, alcohol groups on adjacent cellulose chains are partially crosslinked to keep the chains fixed relative to each other. Over the years, a number of crosslinking agents (also referred to as resins or crosslinkers) have been explored to achieve durable-press (also referred to as wrinkle-free or wrinkle-resistant) properties. In addition, crosslinking agents may improve fabric smoothness, dimensional stability, washfastness of some dyes, pilling resistance, ease of ironing, durability of finishes (repellents, hand modifiers, embossing, etc.), and general appearance. Exemplary crosslinking agents include isocyanates, epoxides, divinylsulfones, aldehydes, chlorohydrins, N-methylol compounds, and polycarboxylic acids. Of these, N-methylol compounds have been used the most, such as dimethylol urea, dimethylol ethylene urea, timethylol trazine, dimethylol methyl carbamate, uron, triazone, and dimethylol dihydroxy ethylene urea (DMDHEU), the latter of which is perhaps the most common durable-press finish used today.

Although the use of crosslinking agents has distinct advantages, there are also some undesirable side-effects, such as a loss in tear and tensile strength, loss in abrasion resistance, reduced moisture regain, possible damage due to chlorine retention, potential odors, potential discoloration, and sewing problems. In other words, treatment with crosslinking agents may render the textiles more brittle, and therefore less robust to laundering, and less comfortable. In addition, many of these crosslinking agents produce undesirable byproducts such as formaldehyde, which complicates the manufacturing process and may contaminate the finished goods.

Durable-press textiles (i.e. resin-treated textiles, also referred to as crosslinked fabrics) also often have stiff, harsh, uncomfortable fabric tactile properties (e.g. the “hand” of the fabric), rendering them rough and stiff to the touch and uncomfortable to wear. Therefore, fabric softeners/lubricants are commonly added to these textiles during the manufacturing process to mitigate some of these deficiencies.

There are four basic types of softeners—anionic, cationic, nonionic, and blended systems. The anionic softeners are generally sulfated or sulfonated compounds used primarily to lubricate yarns through processing. Examples of these compounds include sulfonated tallow, glycerides, and esters. Sulfonated or sulfated castor oil, propyl oleate, butyl oleate, and tallow are used in various steps in dying fabrics. Anionics tend to provide inferior softness compared to the cationics and nonionics. Furthermore, they have limited durability to laundering or dry-cleaning. However, their major limitation comes from the presence of negative charge, which causes incompatibility in resin finishing baths and makes them most sensitive to water hardness and electrolytes. For additional discussion, see, for example, Pushpa Bajaj et. al., (2002) J. Applied Polymer Sci. “Finishing of Textiles,” 82: 631-659.

The cationic softeners are nitrogen-containing compounds including fatty amino amides, imidazolines, amino polysiloxanes, and quaternary cationic nitrogen-containing compounds (also referred to as “quaternaries”). As a result of their positive charge, they are attracted to cotton or synthetic fabrics through electrostatic interactions. They tend to be compatible with most resin finishes and are somewhat durable to laundering. The most significant disadvantage of cationic softeners is their tendency to change the shade or affect the fastness of certain dyestuffs. Discoloration of white fabrics may also be a concern. The development of a fishy odor on the fabric can also be a problem with certain systems.

Nonionic softeners are perhaps the most widely used softeners. This class includes polyethylenes, and water-soluble nonionic softeners, for example, glycerides such as glycerol monostearate, ethoxylates such as ethoxylated castor wax, coconut oil, corn oil, etc., and ethoxylated fatty alcohol and acids. The nonionic softeners offer excellent compatibility in resin baths due to their uncharged state. However, since water-soluble nonionics have no charge, they generally have no specific affinity for fabrics and therefore have relatively low durability to washing. The average durability of many water-soluble nonionics is fewer than 5 home detergent laundry cycles.

To optimize softening and lubricating properties, manufacturers may also formulate a softener blend containing both nonionic and cationic softeners. Typically, an aminosilicone or an imidazolinesilicone, selected for a silky soft slick hand, will be blended with a particular cationic softener or a nonionic polyethylene lubricant for sewability and tear- and abrasion-strength properties. Increased demand for improved hand, cutting lubrication, sewing lubrication and useful life of textiles (including garments) has led to the use of high-density polyethylenes, which are nonionic, as softeners. High-density polyethylenes have decreased solubility in detergent solutions, which results in increased softener durability, however, the durability is still not sufficient for durability after 3 home laundries (HL).

The ability of finishing treatments to impart hydrophilicity or hydrophobicity to a finished product is recognized as an important property of such treatments. Cotton fiber is naturally hydrophilic, and thus easily absorbs water. The common wisdom in the industry was that by crosslinking the cotton, water was prevented from penetrating the fiber. Also, it was thought that the crosslinking agent also formed a crosslinked network, with other crosslinking agent molecules, on the surface of the fiber. It was reasoned that since the crosslinking agent itself is widely considered hydrophobic and the channels for water absorption were closed by the crosslinking network, the crosslinking agent was the reason for the reduction in hydrophilicity of durable press cotton. For this reason, it was thought that the hydrophilicity/hydrophobicity of the softener didn't really matter, as it was believed that using a softener on an already hydrophobic cotton (made hydrophobic by the crosslinking agent) made no difference overall in the fabric's ability to absorb water. Instead, softeners were selected on the basis of their ionicity and the properties associated with that ionicity, as described above. Softeners were selected on softness, strength improvement, worldwide regulatory status, mixture thermal stability, their bath compatibility, and cost. However, we found, surprisingly, that when all softeners were eliminated from the durable press treatment, the wrinkle free cotton (crosslinked cotton) was hydrophilic. Therefore, by judiciously choosing proper softeners, this hydrophilicity could be maintained.

Irrespective of the theory behind the accepted use of hydrophobic crosslinking agents, the hydrophobicity of the finished product causes other problems. For example, hydrophobic cotton-based textiles tend not to be as “comfortable” as untreated cotton, in other words, these hydrophobic cotton-based textiles tend not to exhibit the same beneficial wicking properties or moisture management as untreated cotton. Untreated cotton, as mentioned above, is hydrophilic and is recognized as very efficient at wicking moisture away from the body and remaining comfortable to wear under conditions that promote perspiration. Accordingly, there is a tradeoff between rendering the finished product hydrophobic, in order to resist wrinkles, and ending up with a finished product that is not comfortable to wear. In addition, and as noted above, the hydrophobic crosslinking agents had significant disadvantages related to the robustness of the finished product, in that the crosslinking agents also reduced the strength (both tear and tensile strength) and abrasion resistance of the material, while increasing possible damage due to chlorine retention and the potential for sewing problems, odors, and discoloration. These disadvantages render most wrinkle-resistant products less desirable to the consumer and shorten the product life.

Thus, there has long been a need in the marketplace for wrinkle-resistant comfortable textile products that a) remain durable (the wrinkle resistance and hydrophilicity properties (breathability, wicking, moisture management) are not diminished rapidly with washing; b) have good hand (are pleasing to the touch); and are c) robust (the finished product has sufficient strength and abrasion resistance to withstand laundering and do not discolor, trap odors, and/or retain chlorine after laundering).

The present invention relates, in part, to the recognition that many commonly used crosslinking agents, which were once thought to render fabric hydrophobic, in fact do not effect the hydrophobicity/hydrophilicity of crosslinked textiles, contrary to what was previously believed. Thus, it has been discovered that it is the softener(s) that impart hydrophobicity/hydrophilicity to the finished crosslinked texture, and not the crosslinking agent.

Therefore, careful selection of particular softener combinations used in conjunction with crosslinked textiles results in the preparation of finished products that are resistant to wrinkles and yet retain or improve upon the favorable properties associated with untreated cotton, for example, beneficial wicking (breathability), greater tearing strength, and higher flex abrasion resistance, while also being comfortable and pleasing to the touch.

### BRIEF SUMMARY OF THE INVENTION

The present invention relates to the use of particular combinations of softeners that synergistically interact with crosslinked textiles to produce a superior finished product in terms of wrinkle resistance, hand, strength and hydrophilicity, and which is also able to maintain these properties (durability of softener) with acceptable wear and tear (strength/robustness) after numerous home washings. In view of the findings discussed above, such combinations are chosen primarily based on the hydrophilicity and other characteristics of the softeners, with the crosslinking agent(s) imparting wrinkle resistance. Careful selection is required to produce a finished product that has durable aesthetic qualities (e.g., hand, breathability, etc.) while also producing a product that is hydrophilic and robust enough to survive the wear and tear of laundering as demanded by consumers.

Thus in some aspects the present invention relates, in part, to methods and compositions for treating textiles, including fibrous materials, often cellulosic fibrous substrates, to impart wrinkle resistance and hydrophilicity, while also providing favorable hand, durability and robustness to laundering.

Thus in some embodiments of the present invention, the methods include methods for treating fibrous materials, comprising the steps of:
a) contacting a substrate with a crosslinking agent capable of forming covalent bonds between adjacent cellulose molecules; and
b) simultaneously or sequentially contacting the substrate with a hydrophilic softener combination comprising a mixture of at least two softener components selected from a polyethylene, a hydrophilic quaternary cationic compound and a hydrophilic silicone; wherein the softener components become mechanically or covalently bound to the substrate such that the softener components are detectable after five detergent washes.

In some embodiments of the methods described herein, steps (a) and (b) are performed simultaneously. In other embodiments, steps (a) and (b) are performed sequentially. In certain embodiments of the methods, one or more of step (a) or step (b) further comprises contacting the substrate with one or more additional ingredients. In certain embodiments, step (a) further comprises contacting the substrate with one or more additional ingredients, in others, step (b) further comprises contacting the substrate with one more additional ingredients. In particular embodiments, both step (a) and step (b) further comprise contacting the substrate with one or more additional ingredients. In some embodiments, steps (a) and (b) are performed simultaneously, and one or more additional ingredients are contacted with the substrate.

In another aspect is provided hydrophilic softener combinations.

In another aspect is provided treatment formulations comprising the hydrophilic softener combinations described herein. In certain embodiments, the treatment formulations include one or more crosslinking agents, and may also optionally include one or more catalysts.

In some embodiments, the hydrophilic softener combinations comprise a mixture of at least two softener components selected from a polyethylene, a hydrophilic quaternary cationic compound and a hydrophilic silicone, wherein the softener components are capable of mechanically or covalently binding to a fibrous substrate such that the softener components are detectable after at least five detergent washes of the substrate.

In certain embodiments, the softener components include a polyethylene. In particular embodiments the polyethylene is a hydrophobic polyethylene, in others, a hydrophilic polyethylene.

In certain embodiments, the softener components include a polyethylene, a hydrophilic silicone and a hydrophilic quaternary cationic compound. In some embodiments the softener components include a polyethylene and a hydrophilic silicone, in others a hydrophilic silicone and a hydrophilic quaternary cationic compound, in still others a polyethylene and a hydrophilic quaternary cationic compound.

In certain embodiments more than one polyethylene is present in the hydrophilic softener combination. In some embodiments more than one hydrophilic silicone is present in the hydrophilic softener combination. In some embodiments more than one hydrophilic quaternary cationic compound is present in the hydrophilic softener combination. In other embodiments, one polyethylene, one hydrophilic silicone or one hydrophilic quaternary cationic compound is present in the hydrophilic softener combination.

In some embodiments, the softener components comprise at least one polyethylene, at least one hydrophilic quaternary cationic compound or at least one hydrophilic silicone. In certain embodiments more than one polyethylene is present in the hydrophilic softener combination. In some embodiments more than one hydrophilic quaternary cationic compound is present in the hydrophilic softener combination. In certain embodiments at least one hydrophilic silicone is present.

In some embodiments, the hydrophilic softener combinations described herein may optionally include one or more additional ingredients.

In certain embodiments, the one or more additional ingredients may include one or more finishing auxiliaries, one or more soil release agents, one or more dyes, one or more dye auxiliaries, one or more sulfated oils, one or more flame retardants, one or more preparation scours, one or more surfactants, one or more hydrophilic polyester polymers, one or more hydrophilic emulsifiers, one or more polyurethanes, and one or more soaps. Combinations of two or more additional ingredients are also contemplated.

In particular embodiments, the one or more finishing auxiliaries may include one or more wetting agents and one or more formaldehyde scavengers. In certain embodiments, particularly where the hydrophilic softener combination is added simultaneously with the crosslinking agent, either as a single formulation or addition in the same step of a crosslinking agent formulation and a hydrophilic softener combination formulation, the formulation(s) may also include one or more catalysts. In certain embodiments, the crosslinking agent may be pre-catalyzed.

In some embodiments of the invention described herein, the fibrous material may be a cellulosic fibrous substrate. In certain embodiments, the cellulosic fibrous substrate is cotton. In other embodiments, the cellulosic fibrous substrate is a blend of cotton and another material. In certain embodiments the other material blended with cotton may be, for example, another natural material (e.g., flax, jute, wool, etc.) or a synthetic material (e.g., polyester, rayon, etc.).

Although any material can be treated using the methods described herein, the substrate material is most usually a cellulose fibrous substrate, which may be cotton, or a blend of cotton and other natural or synthetic materials, such as a cotton/polyester blend.

As discussed above, the crosslinking agent and the hydrophilic softener combination can be applied either sequentially or simultaneously. Often, they are applied simultaneously. In some embodiments of simultaneous application, the crosslinking agent and the hydrophilic softener combination are mixed together into a one-step treatment formulation, in other embodiments of simultaneous administration the hydrophilic softener combination and crosslinking agent are in separate treatment formulations. Either or both of the treatment formulations (i.e., the treatment formulations containing the hydrophilic softener combination or the treatment formulation containing the crosslinking agent) may optionally contain one or more additional ingredients. Treatment formulations containing crosslinking agent(s) often contain a catalyst(s).

Unless otherwise noted, the hydrophilic softener combinations and treatment formulations described herein may be used without limitation in the methods described herein, according to the teaching of the specification.

Other aspects and embodiments of the invention are discussed throughout this specification.

### DETAILED DESCRIPTION OF THE INVENTION

The present invention relates to the treatment of textiles to impart wrinkle resistance, hand and durability, as well as compositions for use in such treatments. In one embodiment, it relates to the treatment of linear polymers, yarns, fibers, webs, mesches, fabrics and other fibrous substrates to provide a textile finish that resists wrinkles and yet remains soft to the touch, comfortable to wear and robust to the wear and tear of laundering and use.

Material to be Treated

The textile material to be treated according to the practice of the present invention can be in the form of a polymer, fiber, yarn, web, mesch, fabric, garment, or other form. Accordingly, the treatment may be performed before or after the textile material is formed into a fabric, as well as before or after the fabric is formed into the finished goods.

Cellulosic materials such as cotton and linen may be treated according to the teachings of the present invention. As used herein, the term “cellulosic materials” includes cotton, linen, as well as cotton or linen blends with other synthetic (e.g., polyester, rayon, nylon, lycra, etc.) and natural materials (e.g., flax, jute, wool, etc.). In particular embodiments, the cotton or linen may be blended with one or more than one synthetic material and/or one or more than one natural material.

In addition to cellulosic materials, other materials can be treated, such as polyester, rayon, nylon and the like. Proteinaceous materials such as leather, silk, wool, camel's hair, and alpaca, are also suitable starting materials that may benefit by treatment in accordance with the compositions and methods described herein. While treating non-cellulosic materials with crosslinking agents will not impart wrinkle resistance to these materials, the combination of treatment of these materials with crosslinking agent and hydrophilic softener combination will impart greater durability of the hydrophilic softener components.

In certain embodiments the cellulosic material is cotton or a cotton blend. In particular embodiments the cellulosic material is cotton or a cotton blend with one or more synthetic material(s). In other embodiments, the cellulosic material is cotton or a cotton blend with one or more natural material(s). In some embodiments, the cellulosic material is cotton. In other embodiments, the cellulosic material is linen.

The synthetic or natural materials may be blended with the cotton or linen in ranges from 5%-60%. For example, about 5%, 10%, 20%, 30%, 40%, 50%, 60%, synthetic or natural material, with the balance of the material being cotton or linen. Or, for example, from about 10%-60%, about 20%-60%, about 10%-50%, about 20%-40% synthetic or natural material. As will be understood by those of skill in the art, the composition of blends can also be expressed as a ratio of percentages e.g., a 50/50 cotton/synthetic blend contains 50% cotton and 50% synthetic material.

The treated material may be used in a variety of different applications, such as apparel construction, housewares, as well as industrial uses such as the medical field, automotive industry and furniture industry.

Softener Components

Contrary to previously accepted belief in the field, the crosslinking agents that are commonly used to crosslink cellulose have been found to have a negligible effect on the hydrophobicity/hydrophilicity of finished fabrics. Therefore, surprisingly, it is primarily the softener components that determine fabric hydrophilicity/hydrophobicity and hand. The choice of softener components also has important effects on the physical properties of wrinkle-free finished fabrics, including, for example, strength, which contributes to the robustness of the finished product to the wear and tear of laundering and textile use (e.g., wearing a garment).

In addition to their hydrophilicity, softener component selection is based on the ability to impart wrinkle resistance (e.g., softeners which lubricate the yarns of textiles can contribute to wrinkle resistance by making wrinkles easier to “fall” out or be smoothed by hand), durability, hand, and improvement of fabric strength. To achieve the best performance on cotton fabric, a mixture of different types of softener components should be selected, including at least two of a hydrophilic silicone, a polyethylene, and a hydrophilic quaternary cationic compound.

As used herein, the term “hydrophilic softener combination” refers to a mixture of softener components including at least two of a polyethylene, a hydrophilic silicone and a hydrophilic quaternary cationic compound, where the mixture of softener components is hydrophilic. For example, where the mixture of softener components is able to impart increased hydrophilicity to a crosslinked substrate treated with the mixture. In other words, where the hydrophilicity of the crosslinked substrate treated with the mixture is greater than the hydrophilicity of the same crosslinked substrate which is not treated with the mixture.

When treating a textile including of a cotton/polyester blend, due to the hydrophobic nature of polyester, it is very desirable to treat the textile to impart hydrophilicity to aid in breathability. Softeners useful for imparting desirable characteristics for these types of textiles include hydrophilic silicones (e.g., siloxanes), polyethylenes (e.g., paraffin wax dispersions, hydrophilic polyethylenes), and hydrophilic quaternary cationic molecules. Optionally, the inclusion of hydrophilic polyester polymers also contributes to desirable textile characteristics.

Softeners for use as softener components are further described as below.

Polyethylenes

The term “polyethylene” as used herein refers to the synthetic polymer given by the formula: —(CH₂CH₂)ₙ—, wherein n represents the number of ethylene repeating units in the polymer. Polyethylene can be either linear (high density polyethylene or HDPE) or branched (low density polyethylene or LDPE). The term polyethylene is inclusive of both hydrophobic (unmodified) polyethylene polymers and hydrophilic (modified) polyethylene polymers.

The term “hydrophilic polyethylene” as used herein refers to a modified form of polyethylene that is hydrophilic.

Also as used herein, the term “hydrophilic” refers to compounds that exhibit at least partial hydrophilicity, and thus includes amphiphilic compounds having both hydrophilic and hydrophobic properties, as well as compounds that are hydrophilic overall. Using the example of polyethylene, since the ethylene repeating units of polyethylene are hydrophobic, rendering polyethylene hydrophilic necessarily involves the addition of hydrophilic groups, usually ionic groups. Hydrophilic polyethylene-based softeners are well known in the textile industry and readily commercially available.

For example, a polyethylene that has been modified to contain “polyethylene glycol” moieties (—(CH₂CH₂O)—) is rendered hydrophilic, because the polyethylene glycol portion is hydrophilic. Polyethylenes may also be modified with other polyoxyalkylene (e.g., polyethylene glycol, propylene glycol, etc.). Additionally, the hydrophilic polyethylene may be modified to contain functional groups, such as cationic groups, which may include amines moieties.

Combinations of two or more of the polyethylenes (e.g., combinations of two or more hydrophilic polyethylenes, two or more hydrophobic polyethylenes, or a mixture of hydrophobic and hydrophilic polyethylenes) described herein may also be used in the methods and compositions described herein.

Polyethylenes as described herein are commercially available and include, but are not limited to, for example, Sandolube HD (Clariant), Sandolube ASM (Clariant), Leomin HK (Clariant), Leomin HKS (Clariant), Adline NI (Cognis), Polyavin PEN (CHT), Polyavin NIC (CHT), etc. Additional polyethylenes (both hydrophilic and hydrophobic) may be purchased from suppliers such as CHT, Cognis, Ciba, Clariant, Dow Corning, Boehme Filatex, Piedmont Chemical, Bayer, and BASF, among others known to those in the textile industry.

Hydrophilic Silicones

The term “hydrophilic silicones” is used herein to refer to a class of hydrophilic softeners containing silicone polymers that have been functionalized to render them hydrophilic, usually by the addition of cationic groups such as amino groups. Hydrophilic silicones may also be functionalized with, for example, polyoxyalkylene (e.g., polyethylene glycol, propylene glycol, etc.) and/or epoxy moieties. Examples of hydrophilic silicones include, for example, siloxanes (e.g., amino- and -polyethylene glycol-modified polysiloxane, diquaternary polydimethylsiloxane, epoxy- and propylene glycol-modified polysiloxane, aminopolydimethylsiloxane-polyalkylene oxide, etc.). Additional hydrophilic silicone softeners are amphoteric polydimethylsiloxanes. Another type of hydrophilic silicone softeners are hydroxylic silicones, such as the copolymer of (hydroxyalkyl functional) methylsiloxane and dimethylsiloxane. Such compounds are well known in the textile industry and commercially available (e.g., Dow Corning 8650 (Dow Corning); Ceraperm HIS liquid (Clariant); Tubingal HIS (CHT); Ultraphil® HSD 01 (Ciba); Wetsoft NF 210 E (Wacker), Ultratlex FMW (Ciba), FLUFTONE® SH-RW/FLUFTONE® CHS (Apollo), Magnasoft HWS/Magnasoft EPS/Magnasoft Prime (GE Silicones), Sil-fin WOR (Boehme Filatex), Sandoperm SE1 (Clariant), etc.). Additional hydrophilic silicones may be purchased from suppliers such as CHT, Cognis, Ciba, Clariant, Dow Corning, Boehme Filatex, Piedmont Chemical, Bayer, and BASF, among others known to those in the textile industry.

Combinations of two or more of the hydrophilic silicones described herein may also be used in the methods and compositions described herein.

EPA 300525 discloses fabric conditioners based on crosslinkable amino-functionalized silicones that impart wrinkle control or an easy-iron effect to textiles treated therewith. WO 00124853 describes a fabric softening formulation which provides wrinkle reducing benefits to the treated textiles.

In some embodiments, the silicones are amino-containing silicones, which are preferably present in microemulsified form, alkoxylated, especially ethoxylated, silicones, polyalkylene oxide-polysiloxanes, or polyalkylene oxide-aminopolydimethylsiloxanes, including, without limitation combinations of two or more of the above.

Hydrophilic Quaternary Cationic Compounds

In some embodiments, the hydrophilic quaternary cationic softener is a quaternary ammonium compound, such as a diesterammonium salt, a quaternary tetraalkylammonium salt, a quaternary diamidoammonium salts, an amidoamine ester or an imidazolium salt. Additional examples include quaternary diesterammonium salts which have two C₁₁- to C₂₂-alk(en)ylcarbonyloxy(mono- to pentamethylene) radicals and two C₁- to C₃-alkyl or hydroxyalkyl radicals on the quaternary nitrogen atom and, for example, chloride, bromide, methosulfate or sulfate as a counterion.

Such hydrophilic quaternary cationic compounds as herein described (for example, Hiposoft SFBR (Boehme Filatex), FLUFTONE® OEC-WC (Apollo), Tubingal RWM (CHT), POMOLUBE 72 R (Piedmont Chemical), etc.) are well known and commercially available. Additional hydrophilic quaternary cationic compounds may be purchased from suppliers such as CHT, Cognis, Ciba, Clariant, Dow Corning, Boehme Filatex, Bayer, Piedmont Chemical, and BASF, among others known to those in the textile industry.

Combinations of two or more of the hydrophilic quaternary cationic compounds described herein may also be used in the methods and compositions described herein.

Further description of the softener components, and their physical properties, are described below in Table 1.

The effectiveness of particular hydrophilic softener combinations in imparting particular aesthetic and wear and tear properties, as described throughout this specification, can be measured using the evaluation procedures and test methods described in greater detail below and reported in the examples (e.g., softness, absorbency, vertical wicking, smoothness rating, wrinkle recovery, tensile strength, tearing strength, and flex abrasion resistance). Skilled textile practitioners will also know how to perform and evaluate additional tests and evaluation methods to characterize the effectiveness of particular hydrophilic softener combinations in imparting desirable characteristics to crosslinked textiles.

TABLE 1

| TYPE OF | | |
|---|---|---|
| SOFTENER | ADVANTAGES | DISADVANTAGE |
| Hydrophilic | Silky-soft hand | Expensive |
| Silicones | Increases fabric strength | |
| | Very hydrophilic (breathability) | |
| | Some are durable | |
| Hydrophobic | Increases fabric strength | |
| Polyethylenes | Reasonably durable if applied | |
| | properly | |
| | Good lubrication (sewability) | |
| | Doesn't impair breathability | |
| Hydrophilic | Increases fabric strength | |
| Polyethylenes | Reasonably durable if applied | |
| | properly | |
| | Good lubrication (sewability) | |
| | Hydrophilic (improved | |
| | breathability) | |
| Hydrophilic | Good hand | Contributes to |
| Quaternary | Hydrophilic (some breathability) | potential odors and |
| Cationic | Inexpensive | discoloration |
| Compounds | Somewhat durable | (yellowing/non- |
| | | dyefastness) |

Crosslinking Agents

Most commercial durable press treatments (methods for crosslinking materials) in use today utilize N-methylol compounds, such as dimethyloldihydroxyethyleneurea (DMDHEU). In the presence of heat and Lewis acid catalysts, such as ZnCl₂ or MgCl₂, these N-methylol compounds react readily with the hydroxyl groups of adjacent cellulose chains, forming the desired crosslinks. These crosslinks are quite stable to laundering and allow the fabric to be put through machine washing with detergent without wrinkling, or losing desirable pleats and/or creases which were set in prior to crosslinking. However, as noted previously, the crosslinking process also degrades the strength and robustness of the material to the wear and tear of laundering.

In the practice of the present invention, any crosslinking agent suitable for forming a covalent bond between cellulose molecules can be used. Exemplary crosslinking agents are listed below in Table 2.

As known to those of skill in the textile industry, the efficiency of the crosslinking process can often be enhanced by using a catalyst. For example, such as, Catalyst 531 (Omnova, activated MgCl₂ solution) Selection and use of such catalysts in conjunction with particular crosslinking agents is well within the skill of those in the textile industry. Pre-catalyzed crosslinking agents are also commercial available and can be used as crosslinking agents in the methods and compositions described herein.

Successful crosslinking of the material (e.g., the formation of covalent bonds between adjacent cellulose molecules) can be determined by performing test methods known to those of skill in the art, for example, wrinkle recovery tests, smoothness rating, etc., including the evaluation procedures and test methods described in greater detail herein.

TABLE 2

| CROSSLINKING AGENT | TYPE |
|---|---|
| Dimethyloldihydroxylethyleneurea | High formaldehyde |
| (DMDHEU) | |
| Glycolated DMDHEU | Low formaldehyde |
| Dimethylureaglyoxal (DMUG) | Non-formaldehyde |
| Melamine resins | High formaldehyde |
| Butanetetracarboxylic acid | Non-formaldehyde |
| (BTCA) | |
| Citric Acid | Non-formaldehyde |
| Other polycarboxylic acids | Non-formaldehyde |
| Diisocyanates | Non-formaldehyde |
| Diepoxides | Non-formaldehyde |
| Dihaloalkanes | Non-formaldehyde |

Additional Ingredients

In addition to softener components and the crosslinking agent(s), other ingredients can be added, as described herein, to one or more of the crosslinking treatment formulation, the hydrophilic softener combination, the softener treatment formulation or a one-step treatment formulation. For example, the additional ingredients described below can be added to increase performance or to impart additional characteristics and include, but are not limited to: finishing auxiliaries (wetting agents, such as WetAid NRW, Burcowet WTS, Syntergent TER-1, etc.; formaldehyde scavengers, such as urea, Freetex FSS, sodium borohydride, etc.); soil release agents (e.g., Apollo Dysol PNO, etc.); dyes (e.g., acid blue93, basic orange 1, indanthrone, indigo, etc.); dye auxiliaries (e.g., Alkanol A-CN, Callaway 4035, etc.); sulfated oils (e.g., sulfated vegetable oil, sulfated tall oil, sulfated peanut oil, etc.); flame retardants (e.g., polybrominated phenol ethers, antimony oxide, Antiblaze 100, melamine phosphate, Charmax, etc.); preparation scours (e.g., Sunmorl CS-300, Intratex AR, Gran UP V-50K, Cekapol SSC, etc.); surfactants (e.g., dioctyl sulfosuccinate, ethoxylated alcanols, ethoxylatedalkylphenols, trimethyl ammonium alkyls, dimethyl ammonium dialkyls, etc.), hydrophilic polyester polymers (e.g., Milease T (Clariant), Hipochem CPOS (Boehme Filatex), one or more hydrophilic emulsifiers (e.g., dipropylene glycol, dipropylene glycol mono- and di-methyl ethers, etc.), one or more polyurethanes (e.g., Dicrylan BSRN (Ciba), Baypret USV (Bayer), etc.), or soaps.

One or more, including any combination of two or more of the additional ingredients described herein may be added to the compositions described herein and used in the methods described herein.

Thus, in some embodiments, the additional ingredients may include, for example, one or more wetting agents. In certain embodiments the treatment formulations may include one or more soil release agents.

For treatment of cotton/polyester blends, the compositions described herein may also contain one or more hydrophilic polyester polymers.

The selection and use of the additional ingredients described herein are well known to those of skill in the art and commercially available from numerous suppliers.

Treatment Conditions

Although not wishing to be bound by any particular theory, using the method and compositions of the present invention, it is believed that the softener components become bound to the fibrous material by mechanical and/or covalent means. For example, softener components may be selected such that their functional groups (e.g., amine, epoxy, etc. moieties) become bound (e.g., covalently) to the cellulose fibers. Additionally, owing to their polymeric, hydrophilic nature, they are also expected to become ionically associated with the hydrophilic cellulose, as well as mechanically intertwined with the linear cellulosic fibers.

The treatment of the textile can be performed in a single or multiple step procedure. For example, crosslinking and the addition of the softener components can take place either sequentially or simultaneously. Accordingly, the method can involve the preparation and use of a “crosslinking treatment formulation” along with the hydrophilic softener combination (or, optionally preparation of a “hydrophilic softener treatment formulation” containing the hydrophilic softener combination) or it can involve the preparation and use of a one-step “treatment formulation” containing both the crosslinking agent and the hydrophilic softener combination. Each of the treatment formulations may also contain one or more additional ingredients as described herein, including, without limitation, combinations of two or more additional ingredients as described herein.

Where the crosslinking agent (e.g., “crosslinking treatment formulation”) and softener components (e.g., hydrophilic softener combination or hydrophilic softener treatment formulation containing the hydrophilic softener combination) contact the substrate in separate steps, then addition of catalyst is often included in the crosslinking step and may be included in the crosslinking treatment formulation for ease of use, otherwise, a catalyst or combination of catalysts may be added separately from the crosslinking agent.

The softener components are generally present in a total concentration in a treatment formulation of 0.1% to 30%. In some embodiments, the softener components may each comprise about 0-10% of the total concentration of the treatment formulation (e.g., about 1% to about 8%, about 1% to about 7%, about 1% to about 6%, about 1% to about 5%, about 1% to about 4%, about 1% to about 3%, about 2% to about 5%, about 2% to about 4%, about 1%, about 2%, about 3%, about 4%, about 5%, about 6%, about 7%, about 8%, about 9%, about 10%), so long as at least two softener components are present in a concentration of greater than 0%. In some embodiments the concentration of softener components is about 2% to about 30%, about 3% to about 30%, about 3% to about 20%, about 3% to about 15%, about 3% to about 10%, about 5% to about 20%, about 5% to about 15%, about 5% to about 10%, about 7% to about 20%, about 8% to about 20%, about 7% to about 15%, about 7% to about 10%, or about 5%, about 7%, about 8%, about 10%, or about 15%.

For example, in a representative treatment method for one-step application of the crosslinking agent(s) and softener components, the finishing bath, containing the treatment formulation, usually contains certain concentrations of crosslinking agent(s) and softener components. In particular representative embodiments, the treatment formulation may contain certain concentrations of crosslinking agent(s), catalyst(s), wetting agent(s), and softener components. These treatment formulations may optionally contain one or more of the finishing auxiliaries, soil release agents, dyes, dye auxiliaries, sulfated oil, flame retardants, preparation scours, surfactants, hydrophilic emulsifiers, hydrophilic polyester polymers, polyurethanes, and soaps described herein.

The compositions described herein can be applied to the textile by, for example, a conventional padding method (see e.g., W. D. Schindler and P. J. Hauser; Chemical Finishing of Textiles; Woodhead Publishing Limited, Cambridge England, 2004, Chapter 5: “Easy-Care and Durable Press Finishes of Cellulosics”; pp 51-72, and references cited therein), and then the textile is dried and cured as described herein.

The treatment conditions and hydrophilic softener combination should be chosen such that the softener components are not easily removed from the treated textile during normal detergent washing, for example home laundering, commercial laundering or dry cleaning.

For example, the softener components should be detectable after five detergent washes. In particular embodiments, the softener components are detectable after three, five, ten, fifteen, twenty, twenty-five or thirty detergent washes. In some embodiments, the softener components are detectable after about 3 to about 10 detergent washes, after about 5 to about 10 detergent washes, about 5 to about 15 detergent washes, about 5 to about 20 detergent washes, about 5 to about 30 detergent washes, about 10 to about 20 detergent washes, about 10 to about 30 detergent washes, about 15 to about 30 detergent washes, about 15 to about 25 detergent washes, or about 20 to about 30 detergent washes.

The presence of the softener components on the hydrophilic softener combination-treated crosslinked textile can be detected by any of the detection methods known to those of skill in the art, including, but not limited to, for example, detection of the softener components by infra-red (IR, e.g., Fourier Transform-IR (FTIR)) after the crosslinked textile has been dissolved in acid or ground into powder form.

Additionally, the present of softener components on crosslinked textiles can be determined by measuring the molecular weight of the crosslinked textile, and comparing the molecular weights of, for example, untreated, treated and treated/washed crosslinked textile. An increase in molecular weight after treatment of the crosslinked textile with the hydrophilic softener combination indicates the presence of the softener components on the hydrophilic textile. Maintenance of a molecular weight for the treated textile of greater than that of the untreated textile after a particular number of detergent washes is indicative of the durability of the softener components and indicates that the softener components are mechanically or covalently-bound to the crosslinked textile.

Another means to assess the durability of the hydrophilic softener combination is a side by side comparison of hand between treated and untreated substrate after repeated launderings. Durable softener has noticeably better hand than untreated after many laundering cycles.

As is well known to those in the art, in the conventional padding methods used in the textile industry, also referred to as pad-dry or pad-dry-cure methods, the material is immersed in an aqueous solution containing the finishing chemicals to be applied to the material for several seconds or minutes (often at least 10 minutes). The wet material is then is passed through rollers to squeeze out liquid until a desired wet pick-up is reached. Wet pick up is usually measured as a % of material weight compared to the dry weight of the fabric. The fabric is then dried and/or cured.

In certain embodiments, the wet pick-up of the fabric will be from about 30% to about 100%. For example, in particular embodiments the wet pick up will be from about 30% to about 70%, from about 40% to about 70%, from about 50% to about 70%, from about 55% to about 70%, from about 50% to about 80%, from about 60% to about 75%, from about 60% to about 70%, from about 60% to about 80% or from about 60% to about 65%.

In some embodiments, the textile will be immersed in the finishing chemicals (including, for example the compositions described herein) for at least 2 seconds, for at least 3 seconds, for at least 4 seconds, for at least 5 seconds, for at least 7 seconds, for at least 10 seconds, for at least 15 seconds, for at least 20 seconds, for at least 25 seconds, for at least 30 seconds, for at least 45 seconds, for at least 60 seconds, for at least 2 minutes, for at least 3 minutes, for at least 5 minutes, for at least 10 minutes, for at least 15 minutes, for at least 20 minutes, or for at least 30 minutes. In certain embodiments, the textile will be immersed in the finishing chemicals (including, for example the compositions described herein) for about 2 seconds to about 20 minutes, for about 5 seconds to about 20 minutes, for about 4 seconds to about 10 seconds, for about 10 seconds to about 20 minutes, for about 2 seconds to about 2 minutes, for about 5 seconds to about 2 minutes, for about 10 seconds to about 10 minutes, 20 for about 2 to about 20 minutes, for about 3 to about 20 minutes, for about 5 to about 20 minutes, for about 5 to about 30 minutes, for about 10 to about 30 minutes, for about 10 to about 20 minutes, or for about 10 to about 15 minutes. In particular embodiments, the textile will be immersed in the finishing chemicals (including, for example the compositions described herein) for about 2 seconds, for about 5 seconds, for about 10 seconds, for about 15 seconds, for about 20 seconds, for about 30 seconds, for about 45 seconds, or for about 60 seconds.

The textiles can be dried by methods known to those of skill in the art under well known conditions, including, for example, drying in an oven or air drying. Oven drying may occur at temperatures, for example, less than 100° C., for example from about 50° C. to about 100° C., from about from about 70° C. to about 100° C., from about 80° C. to about 100° C., from about 90° C. to about 100° C., or from about 80° C. to about 95° C.

Curing may be also be accomplished by methods well known to those of skill in the art. Possible curing methods include heating the textile in a suitable vessel at temperatures of, for example about 100° C. to about 200° C. In some embodiments, the textile may be cured at from about 100° C. to about 150° C., from 100° C. to about 175° C., from about 125° C. to about 175° C., or at about 100° C., about 125° C., about 140° C., about 150° C. or about 175° C.

In some embodiments, as known to those of skill in the textile industry, the drying and curing steps may be accomplished simultaneously. However, as is known, often the crosslinking efficiency is not as great under such conditions as when the textile is first dried and then cured. Skilled textile practitioners will also understand how to optimize the parameters of wet-pick-up, coating, drying and curing for particular textiles based on the content, weight and type of textile being treated.

Particular exemplary hydrophilic softener combination/crosslinking agent formulations are listed below. These formulations may optionally contain one or more of the finishing auxiliaries, soil-release agents, dyes, dye auxiliaries, sulfated oil, flame retardants, preparation scours, surfactants, hydrophilic emulsifiers, hydrophilic polyester polymers, polyurethanes and soaps described herein. All weights are based on the weight of the bath solution.

| | EXEMPLARY 50/50 |
|---|---|
| EXEMPLARY 100% | COTTON/POLYESTER |
| COTTON SHIRTING | BLEND SHIRTING |
| TREATMENT SOLUTION | TREATMENT SOLUTIONS |
| 16% DMDHEU (crosslinker) | 8% DMDHEU |
| Hydrophilic Softener Combination | Hydrophilic Softener Combination |
| 7% (total) (3% hydrophilic | 8% (total) (4% hydrophilic silicone, |
| Silicone, 2% polyethylene and 2% | 3% polyethylene and 1% hydrophilic |
| hydrophilic quaternary cationic) | quaternary cationic) |
| | Hydrophilic Softener Combination |
| | 8% (total) (3% hydrophilic silicone, |
| | 2% polyethylene, 2% hydrophilic |
| | quaternary cationic, 1% hydrophilic |
| | polyester) |

In a representative embodiment, the method of the present invention involves a one-step treatment formulation comprising a crosslinking agent, a hydrophilic softener combination including softener components of a hydrophilic silicone, hydrophilic quaternary cationic compound and a polyethylene, a wetting agent and a catalyst.

Testing Methods

As noted previously, the finished textiles and/or finished product (e.g., shirts, pants, etc.) can be tested using a variety of known industry standard testing procedures. For example, the American Association of Textile Chemists and Colorists (AATCC), ASTM International (formerly the American Society for Testing and Materials) and other trade organizations and manufactures provide publicly available industry guidelines for standardizing “performance” testing of textile materials.

Examples of these testing procedures and evaluation methods that can be used to characterize textiles as described herein are listed below:
Softness—AATCC Evaluation Procedure 5
Absorbency—AATCC Test Method 79-2000
Vertical Wicking—Nike PF3 2001
Smoothness rating—AATCC Test Method 124-2001
Wrinkle recovery—AATCC Test Method 66-1998
Tensile strength—ASTM D 5035-95
Tearing strength—ASTM D 1424-96
Flex abrasion resistance—ASTM D 3885-92

For example, as known to the skilled practitioners the “softness” evaluation procedure is often used as an indication of the “hand” of a textile, while “wrinkle recovery” and “smoothness rating” (also referred to as DP (durable press) rating) are often used to evaluate the efficiency of crosslinking and ability of a textile to remain wrinkle-free. Tests for the hydrophilicity of a test textile include, for example, the test for absorbency (also referred to as wetting time) and/or wicking height. In general, crosslinked textiles with wetting times of less than 40 seconds are considered hydrophilic, where a shorter wetting time is indicative of a more hydrophilic textile. For example, untreated, non-crosslinked cotton shirting fabric on average has an average wetting time of about 10 seconds, while a non-crosslinked 50/50 cotton/polyester blend has an average wetting time of about 15 seconds. Commercial wrinkle-free cotton shirting fabric on average has an average wetting time of about 120 seconds, while commercial wrinkle-free 50/50 cotton/polyester blend has an average wetting time of about 150 seconds.

In addition to the performance testing described above, which includes a test for the softness of a fabric after treatment, softener component durability (i.e. the ability of the softener to remain present after numerous washes) can also be determined using chemical testing. For example as mentioned previously, the presence of the softener components can be determined by subjecting treated textiles to several home laundry (HL) cycles and subsequently grinding up samples of the fabric. Thereafter, FTIR testing can be performed on a KBr pellet, which would produce a peak associated with each softener. Comparison with untreated samples of the same textile can serve as a control and confirm that the observed peak is associated with the softener components.

Since one important aspect of the present invention is to render the treated material hydrophilic, it is desirable for the treated product to exhibit a wetting time of less than 40 seconds, and a wicking height of greater than 10 centimeters (after 30 min.). In some embodiments, the wetting time is less than about 30 seconds, less than about 25 seconds, less than about 20 seconds, less than about 15 seconds, less than about 10 seconds, or less than about 5 seconds.

In some embodiments the wicking height is about 10 to about 15 centimeters or about 15 to about 20 centimeters.

Exemplary properties of 100% cotton fabric (2.9 oz/yard²) and 50/50 cotton/polyester blend fabric (4.1 oz/yard²) are shown below in Table 3. Relative values indicated in Table 3 are given for crosslinked/softener-treated fabric relative to fabric that has not been treated with hydrophilic softener combination and has not been crosslinked.

TABLE 3

| | | 50/50 COTTON/ |
|---|---|---|
| TEST METHOD | 100% COTTON | POLYESTER |
| Tearing @ OHL | <20% loss | <20% loss |
| (fill, N) | | |
| Flex Abrasion @ 0HL | <40% loss | <2-fold increase |
| (fill, 1 × 4, cycles) | | |
| DP Rating @ 3HL | >3 | >3.5 |
| Wetting time @ 1HL | <20 | <20 |
| (seconds) | | |
| Vertical Wicking @ 1HL | >10 | >10 |
| (fill, 30 min., cm) | | |
| Hand @ 0HL | Soft | Soft |

Comparison between fabric treated with the hydrophilic softener combinations described herein (referred to as “comfort wrinkle-free”, or “CWF”) and commercially available wrinkle-free textiles for both 100% cotton and cotton/polyester fabrics shows that the CWF textiles have the following advantages over commercially available wrinkle-free textiles:
1) Super hydrophilicity—CWF absorbs water about ten times faster than general finishing system.
2) Better physical properties—CWF finished fabrics have higher flex abrasion resistance and tearing strength than commercial products, especially for cotton/polyester fabric, flex abrasion cycles of CWF finished fabric was doubled.
3) Similar or better hand—CWF fabric has comparable or better hand than the best commercial wrinkle-free system.

The information presented above is provided to give those of ordinary skill in the art with a complete disclosure and description of how to make and use the preferred embodiments of the invention, and is not intended to limit the scope of what the inventor(s) regard(s) as his or her/their invention. Modifications of the above-described modes for carrying out the invention that are obvious to persons of skill in the art are intended to be within the scope of the following claims. All publications, patents, and patent applications cited in this specification are incorporated herein by reference as if each such publication, patent or patent application were specifically and individually indicated to be incorporated herein by reference.

### EXAMPLES

All weights are based on the weights of bath solution.

Unless otherwise noted, all fabric samples were tested according to standard testing protocols described herein and results shown in tabular form. Testing methods refer to the ASTM and AATCC testing methods/evaluation procedures described in the section “Testing Methods,” above.

### Example 1

### Comparison of 100% Cotton and Cotton/Polyester Fabrics

Finishing bath contains listed concentrations of crosslinkers, catalysts, wetting agents, and hydrophilic softener combination. Solutions were applied onto fabric by conventional padding method, then the fabric was dried and cured as indicated.

Formulation A (100% cotton shirting fabric (2.9 oz/sq. yard)):

16% Permafresh TG (Commercial product from Omnova, glycolated DMDHEU)
3.6% Catalyst 531 (Omnova)
0.2% WetAid NRW
7% Softener components (3% commercial hydrophilic silicone+2% commercial polyethylene+2% commercial hydrophilic quaternary cationic compound)
Solution adjusted to pH to 3.5-4.0 with NaOH and HCl
   Formulation B (50/50 cotton/polyester shirting fabric (4.1 oz/sq. yard)):
8% Permafresh TG (Commercial product from Omnova)
2.5% Catalyst 531 (Omnova)
0.2% WetAid NRW
7% Softener components (4% commercial hydrophilic silicone+3% commercial polyethylene)
1% hydrophilic polyester polymer
Solution adjusted to pH to 3.5-4.0 with NaOH and HCl

Fabric was dipped into the solution and padded to 60-65% wet pick-up. The fabric was dried at 176° F. (80° C.) for 3 minutes, and then cured at 350° F. (176.7° C.) for 1 minute.

The results are shown below in Table 4.

TABLE 4
Properties of finished 100% cotton fabric
(0.181 lb/sq yard (or 2.9 oz/sq. yard)) and
50/50 cotton/polyester fabric (0.258 lb/sq yard (or 4.1 oz/sq. yard))

| | 100% | 50/50 |
|---|---|---|
| | cotton | cotton/polyester |
| Tensile @ 0HL (fill, N) | 119.6 | 139.7 |
| Tearing @ 0HL (fill, N) | 7.4 | 13.6 |
| Flex abrasion @ 0HL | 95 | 821 |
| (fill, 1 × 4, cycles) | | |
| WRA @ 0HL | 263 | 282 |
| (W + F, degree) | | |
| DP rating @ 3HL | 3.4 | 4.0 |
| Wetting time @ 1HL | 12 | 9 |
| (seconds) | | |
| Vertical wicking @ 1HL | 12.3 | 11.9 |
| (fill, 30 min., cm) | | |
| Hand @ 0HL | Soft | Soft |

### Example 2

### Comparison of 100% Cotton and Cotton/Polyester Fabrics, both Treated and Untreated

In Table 5, below, “treated” fabric refers to crosslinked (wrinkle-free) hydrophilic softener combination-treated fabric and “untreated” refers to fabric which has not been crosslinked or treated with a hydrophilic softener combination. The treated fabric was prepared as described below using the same commercial hydrophilic silicone, hydrophilic quaternary cationic compound, and polyethylene as used in Example 1. Examples 1 and 2 used the same type of fabric (as described) but were obtained from different lots and in different colors.

Formulation A (100% cotton shirting fabric (3.0 oz/sq yard)):

16% DMDHEU
Softener components, 7% total:
3% commercial hydrophilic silicone, 2% commercial polyethylene and 2% commercial hydrophilic quaternary cationic
   Formulation B (50/50 cotton/polyester shirting fabric (4.1 oz/sq yard)):
8% DMDHEU
Softener components, 7% total:
(4% commercial hydrophilic silicone, 3% commercial polyethylene)
1% commercial hydrophilic polyester polymer

Fabric was dipped into the solution A or B, according to fabric type, as described above and padded to 60-65% wet pick-up. The fabric was dried at 176° F. (80° C.) for 3 minutes, and then cured at 350° F. (176.7° C.) for 1 minute.

TABLE 5

| | | | | 50/50 |
|---|---|---|---|---|
| | | | 50/50 | COTTON/ |
| | 100% | 100% | COTTON/ | POLY- |
| | COTTON | COTTON | POLY- | ESTER |
| | TREAT- | UN- | ESTER | UN- |
| TEST METHOD | ED | TREATED | TREATED | TREATED |
| Tensile @ OHL | 74.5 | 168.9 | 139.7 | 179.1 |
| (fill, N) | | | | |
| Tearing @ OHL | 4.1 | 4.9 | 13.6 | 13.3 |
| (fill, N) | | | | |
| Flex Abrasion @ | 70 | 115 | 821 | 208 |
| 0HL (fill, 1 × 4, | | | | |
| cycles) | | | | |
| WRA @ 0HL | 263 | 107 | 282 | 199 |
| (W + F, degree) | | | | |
| DP Rating @ | 3.4 | 1.0 | 4.0 | 2.0 |
| 3HL | | | | |
| Wetting time @ | 12 | 8 | 9 | 3 |
| 1HL (seconds) | | | | |
| Vertical Wicking | 12.3 | | 11.9 | |
| @ 1HL (fill, | | | | |
| 30 min., cm) | | | | |
| Hand @ 0HL | Soft | Stiff | Soft | Stiff |
| Wetting time @ | 10 | 8 | 6 | 2 |
| 5HL (seconds) | | | | |
| Hand @ 5HL | soft | Stiff | soft | stiff |

### Example 3

### 100% Ammonia Mercerized Cotton Shirting Fabric, 3 oz Per Square Yard with Varying Percentages of Hydrophilic Softener Combination

Varying percentages of hydrophilic softener combination were tested with 100% ammonia mercerized cotton shirting fabric, 3 oz per square yard. The varying percentages of hydrophilic softener combination were added to the finishing formulation as shown in Table 6. The results are tabulated in Table 6. The treated fabric was prepared as described below using the same commercial hydrophilic silicone, commercial hydrophilic quaternary cationic compound, and commercial polyethylene as used in Example 1.

Finishing Formulation:

16% Permafresh TG (Commercial product from Omnova, glycolated DMDHEU)
3.6% Catalyst 531 (Onmova)
0.2% WetAid NRW
Softener components (commercial hydrophilic silicone:commercial polyethylene:commercial hydrophilic quaternary cationic compound=3:2:2)
Adjusted solution pH to 3.5-4.0 with NaOH and HCl

The fabric was dipped into the finishing formulation as described above and padded to 60-65% wet pick-up. The fabric was dried at 176° F. (80° C.) for 3 minutes, and then cured at 350° F. (176.7° C.) for 1 minute.

TABLE 6

| | | | Softener | | |
|---|---|---|---|---|---|
| | | | concentration, % | | |
| Home | Properties | Control, | 3 | 5 | 7 |
| Initial | Hand Average (1 | 4 | 3 | 2 | 1 |
| | is the best) | | | | |
| | Wicking (after 5 min, | 4.0 | 4.4 | 4.7 | 4.9 |
| | cm) warp | | | | |
| | Wicking (after | 8.2 | 9.2 | 10.0 | 9.6 |
| | 30 min, cm) | | | | |
| | warp | | | | |
| | Wicking (after 5 min, | 4.0 | 4.2 | 4.4 | 4.3 |
| | cm) fill | | | | |
| | Wicking (after | 8.3 | 9.0 | 9.0 | 8.9 |
| | 30 min, cm) fill | | | | |
| | Wetting time, sec | 33 | 31 | 25 | 19 |
| | Flex Abrasion | 698 | 356 | 606 | 632 |
| | (warp) | | | | |
| | Flex Abrasion | 465 | 218 | 199 | 119 |
| | (fill) | | | | |
| | Tensile (warp) | 524.6 | 324.3 | 320.8 | 307.6 |
| | Tensile (fill) | 187.1 | 95.0 | 84.3 | 92.8 |
| | Tear (warp) | 11.9 | 9.2 | 7.5 | 7.9 |
| | Tear (fill) | 6.8 | 7.5 | 7.3 | 7.6 |
| 1X plus an | Hand Average | 4 | 3 | 2 | 2 |
| extra | Wicking (after 5 min, | 4.4 | 4.9 | 5.1 | 5.3 |
| washing | cm) warp | | | | |
| cycle | Wicking (after | 10.2 | 10.8 | 11.0 | 11.3 |
| without | 30 min, cm) | | | | |
| detergent | warp | | | | |
| | Wicking (after 5 min, | 4.0 | 4.3 | 4.4 | 4.6 |
| | cm) fill | | | | |
| | Wicking (after | 8.4 | 8.5 | 8.9 | 9.1 |
| | 30 min, cm) fill | | | | |
| | Wetting time, sec | 10 | 46 | 33 | 35 |
| 3X plus an | Hand Average | 4 | 3 | 2 | 1 |
| extra | Wicking (after 5 min, | 6.3 | 4.5 | 4.9 | 5.2 |
| washing | cm) warp | | | | |
| cycle | Wicking (after | 11.8 | 10.8 | 10.6 | 10.9 |
| without | 30 min, cm) | | | | |
| detergent | warp | | | | |
| | Wicking (after 5 min, | 5.3 | 4.1 | 4.6 | 4.8 |
| | cm) fill | | | | |
| | Wicking (after | 9.8 | 8.7 | 9.0 | 9.4 |
| | 30 min, cm) fill | | | | |
| | Wetting time, sec | 12 | 32 | 20 | 25 |
| | Smoothness/DP | 1.3 | 3.2 | 3.4 | 3.1 |
| Home | | Control, | Softener | | |
| laundry | | 0.2% | concentration, % | | |
| cycles | Properties | WetAid | 3 | 5 | 7 |
| 10X plus an | Hand Average | 4 | 3 | 2 | 1 |
| extra | | | | | |
| washing | | | | | |
| cycle | | | | | |
| without | | | | | |
| detergent | | | | | |

### Example 4

### 50/50 Polyester/Cotton Lacoste® Knit Fabric, 7.2 oz Per Square Yard

A finishing solution of 5% hydrophilic softener combination was tested with 50/50 polyester/cotton Lacoste® knit fabric, 7.2 oz per square yard after varying numbers of home laundry (HL) cycles and compared with tests of untreated (non-crosslinked with no hydrophilic softener combination treatment). The treated fabric was prepared as described below using the same commercial hydrophilic silicone, commercial hydrophilic quaternary cationic compound, and commercial polyethylene as used in Example 1. The results are tabulated in Table 7.

Finishing Formulation:

12.5% Freerez 845 (Commercial product from Noveon)
0.4% Trycol 5953 (wetting agent)
5% Softener components (commercial hydrophilic silicone:commercial polyethylene:commercial hydrophilic quaternary cationic compound=3:2:2)
1% hydrophilic polyester polymer
Adjusted solution pH to 4.2 with NaOH and HCl

The fabric was dipped into the finishing formulation above and padded to 75% wet pick-up. The fabric sample was then dried and cured using a one step dry/cure 320° F. (160° C.) for 80 seconds.

TABLE 7

| Home | | | |
|---|---|---|---|
| laundry | | | |
| cycles | Properties | Untreated | Treated |
| Initial | Wicking (after 5 min, cm) | 11.0 | 9.8 |
| | warp | | |
| | Wicking (after 30 min, | 15.0 | 15.0 |
| | cm) warp | | |
| | Wicking (after 5 min, cm) | 9.9 | 8.9 |
| | fill | | |
| | Wicking (after 30 min, | 15.0 | 15.0 |
| | cm) fill | | |
| | Wetting time, sec | 0 | 0 |
| 1X | Wicking (after 5 min, cm) | 12.1 | 8.3 |
| | warp | | |
| | Wicking (after 30 min, | 15.0 | 15.0 |
| | cm) warp | | |
| | Wicking (after 5 min, cm) | 10.7 | 8.4 |
| | fill | | |
| | Wicking (after 30 min, | 15.0 | 15.0 |
| | cm) fill | | |
| | Wetting time, sec | 0 | 2 |
| 3X | Wicking (after 5 min, cm) | 11.5 | 9.4 |
| | warp | | |
| | Wicking (after 30 min, | 15.0 | 15.0 |
| | cm) warp | | |
| | Wicking (after 5 min, cm) | 10.6 | 8.9 |
| | fill | | |
| | Wicking (after 30 min, | 15.0 | 15.0 |
| | cm) fill | | |
| | Wetting time, sec | 0 | 2 |
| | Smoothness/DP | 3.2 | 4.1 |
| 20X | Wicking (after 5 min, cm) | 12.4 | 10.1 |
| | warp | | |
| | Wicking (after 30 min, | 15.0 | 15.0 |
| | cm) warp | | |
| | Wicking (after 5 min, cm) | 11.3 | 9.6 |
| | fill | | |
| | Wicking (after 30 min, | 15.0 | 15.0 |
| | cm) fill | | |
| | Wetting time, sec | 0 | 1 |

### Example 5

### 100% Mercerized Cotton Shirting Fabric, 3 oz Per Square Yard

A finishing formulation as described below was tested with 100% mercerized cotton shirting fabric, 3 oz per square yard after varying numbers of home laundry (HL) cycles. The treated fabric was prepared as described below using the same commercial hydrophilic silicone and commercial hydrophilic quaternary cationic compound as used in Example 1. The results are tabulated in Table 8.

Finishing Formulation:

16% Permafresh TG (Commercial product from Omnova, glycolated DMDHEU)
3.6% Catalyst 531 (Omnova)
0.2% WetAid NRW
7% Softener components (commercial hydrophilic silicone:commercial hydrophilic polyethylene:commercial hydrophilic quaternary cationic compound=3:2:2)
Adjusted solution pH to 3.5-4.0 with NaOH and HCl
   Application Procedure:

The fabric was dipped into the finishing formulation as described above and padded to 60-65% wet pick-up. The fabric was dried at 176° F. (80° C.) for 3 minutes, and then cured at 350° F. (176.7° C.) for 1 minute.

TABLE 8

| | 100% COTTON |
|---|---|
| TEST METHOD | TREATED |
| Tensile @ 0HL | 96.2 |
| (fill, N) | |
| Tearing @ 0HL | 6.5 |
| (fill, N) | |
| Flex Abrasion @ 0HL | 70 |
| (fill, 1 × 4, cycles) | |
| DP Rating @ 3HL | 3.2 |
| Wetting time @ 1HL | 12 |
| (seconds) | |
| Hand @ 0HL | Soft |
| Wetting time @ 3HL | 9 |
| (seconds) | |
| Hand @ 3HL | soft |

### Example 6

### 100% Mercerized Cotton Shirting Fabric, 3 oz Per Square Yard)

A finishing formulation as described below was tested with 100% mercerized cotton shirting fabric, 3 oz per square yard after varying numbers of home laundry (HL) cycles. The treated fabric was prepared as described below using the same commercial polyethylene and commercial hydrophilic quaternary cationic compound as used in Example 1. The commercial hydrophilic silicone was different. The results are tabulated in Table 9.

Finishing Formulation:

16% Permafresh TG (Commercial product from Onmova, glycolated DMDHEU)
3.6% Catalyst 531 (Omnova)
0.2% WetAid NRW
7% Softener components (commercial hydrophilic silicone: commercial polyethylene:commercial hydrophilic quaternary cationic compound=3:2:2)
Adjusted solution pH to 3.5-4.0 with NaOH and HCl

The fabric was dipped into the finishing formulation as described above and padded to 60-65% wet pick-up. The fabric was dried at 176° F. (80° C.) for 3 minutes, and then cured at 350° F. (176.7° C.) for 1 minute.

TABLE 9

| | 100% COTTON |
|---|---|
| TEST METHOD | TREATED |
| Tensile @ 0HL | 95.3 |
| (fill, N) | |
| Tearing @ 0HL | 8.4 |
| (fill, N) | |
| Flex Abrasion @ 0HL | 208 |
| (fill, 1 × 4, cycles) | |
| DP Rating @ 3HL | 2.8 |
| Wetting time @ 1HL | 28 |
| (seconds) | |
| Hand @ 0HL | Soft |
| Wetting time @ 3HL | 23 |
| (seconds) | |
| Hand @ 3HL | soft |
| Wetting time @ 5HL | 13 |
| (seconds) | |

What is claimed as new and desired to be protected by Letters Patent of the United States is:

1. A method for treating a cellulosic fibrous substrate, the method comprising the steps of:
a) contacting the substrate with a crosslinking agent capable of forming covalent bonds between adjacent cellulose molecules; and
b) simultaneously or sequentially contacting the substrate with a hydrophilic softener combination comprising a mixture of at least two softener components selected from the group consisting of a polyethylene, a hydrophilic quaternary cationic compound and a hydrophilic silicone;
wherein the softener components become mechanically or covalently bound to the substrate such that the softener components are detectable after five detergent washes.

2. The method of claim 1, wherein the hydrophilic softener combination comprises two of the softener components selected from the group consisting of a polyethylene, a hydrophilic quaternary cationic compound and a hydrophilic silicone.

3. The method of claim 1, wherein the softener components comprise a polyethylene, a hydrophilic quaternary cationic compound and a hydrophilic silicone.

4. The method of claim 1, wherein the polyethylene is a hydrophilic polyethylene.

5. The method of claim 1, wherein the polyethylene is a hydrophobic polyethylene.

6. The method of claim 1, wherein the substrate is cotton.

7. The method of claim 1, wherein the substrate is a blend of cotton and another material.

8. The method of claim 7, wherein the other material is polyester.

9. The method of claim 8, wherein either step (a or step (b further comprises contacting the substrate with a hydrophilic polyester polymer.

10. The method of claim 1, wherein the softener components are detectable after ten detergent washes.

11. The method of claim 1, wherein the softener components are detectable after twenty detergent washes.

12. The method of claim 1, wherein steps a) and b) are performed simultaneously.

13. The method of claim 1, wherein steps a) and b) are performed sequentially.

14. The method of claim 1, wherein step a) further comprises contacting the substrate with one or more catalysts.

15. The method of claim 1, wherein step a) or b) further comprises contacting the substrate with one or more additional ingredients.

16. The method of claim 15, wherein the one or more additional ingredients are selected from the group consisting of one or more finishing auxiliaries, one or more soil release agents, one or more dyes, one or more dye auxiliaries, one or more sulfated oils, one or more flame retardants, one or more preparation scours, one or more hydrophilic polyester polymers, one or more polyurethanes, one or more hydrophilic emulsifiers, one or more surfactants, and one or more soaps.

17. The method of claim 16, wherein the one or more finishing auxiliaries is selected from the group consisting of one or more wetting agents and one or more formaldehyde scavengers.

18. The method of claim 16, wherein the additional ingredients comprise one or more wetting agents and one or more hydrophilic polyester polymers.

19. A hydrophilic softener combination comprising a mixture of at least two softener components selected from the group consisting of a polyethylene, a hydrophilic quaternary cationic compound and a hydrophilic silicone,
wherein the softener components are capable of mechanically or covalently binding to a cellulosic fibrous substrate such that the softener components are detectable after five detergent washes of the substrate.

20. The hydrophilic softener combination of claim 19, wherein the polyethylene is a hydrophobic polyethylene.

21. The hydrophilic softener combination of claim 19, wherein the polyethylene is a hydrophilic polyethylene.

22. The hydrophilic softener combination of claim 19, wherein the softener components comprise a polyethylene, a hydrophilic quaternary cationic compound and a hydrophilic silicone

23. The hydrophilic softener combination of claim 19, further comprising one or more additional ingredients.

24. The hydrophilic softener combination of claim 23, wherein the one or more additional ingredients are selected from the group consisting of one or more finishing auxiliaries, one or more soil release agents, one or more dyes, one or more dye auxiliaries, one or more sulfated oils, one or more flame retardants, one or more preparation scours, one or more hydrophilic polyester polymers, one or more hydrophilic emulsifiers, one or more polyurethanes, one or more surfactants, and one or more soaps.

25. The hydrophilic softener combination of claim 24, wherein the one or more one or more finishing auxiliaries are selected from the group consisting of one or more wetting agents and one or more formaldehyde scavengers.

26. The hydrophilic softener combination of claim 24, wherein the additional ingredients comprise one or more wetting agents and one or more hydrophilic polyester polymers.
